(19) United States
(12) Patent Application Publication
(10) Pub. No.: US 2006/0147052 A1
(43) Pub. Date: Jul. 6, 2006

(54) Audio headphone having wireless transceiver and analog audio input

(76) Inventors: Harold L. Wikel, Muskego, WI (US); Jon Godston, Chicago, IL (US); Edward D. Brann, Chicago, IL (US)

Correspondence Address: MOTOROLA INC, 600 NORTH US HIGHWAY 45, ROOM AS437, LIBERTYVILLE, IL, 60048-5343, US

(21) Appl. No.: 11/029,085

(22) Filed: Jan. 4, 2005

(51) Int. Cl. H04R 1/10; H04R 25/00; H04M 1/00

(52) U.S. Cl. 381/74; 381/384; 455/575.2

(57) ABSTRACT

An audio headset (100) including one or two earphone pods (110, 120) each having an audio transducer, wherein a lanyard (130) interconnects a pair of pods. A wireless receiver is disposed in one of the earphone pods, wherein the wireless receiver includes an audio signal output coupled to at least one of the audio transducers. An analog audio jack having an audio signal output is also coupled to one of the audio transducers.

### FIELD OF THE DISCLOSURE

The present disclosure relates generally to audio headphones, and more particularly to audio headphones, or headsets, having a wireless transceiver, for example, a personal space transceiver, and an integrated analog audio signal input, sub-components and methods.

### BACKGROUND OF THE DISCLOSURE

Wireless audio headsets are known generally. U.S. Patent Publication No. 2003/0073460 entitled “Modular Headset For Cellphone or MP3 Player”, for example, discloses a modular headset having first and second headphone units. In Publication No. 2003/0073460, one headphone unit serves a mobile phone wireless earpiece in a first operational mode, and a second headphone unit generates stereo audio when coupled to an MP3 player in a second operational mode, wherein resources of the second headphone unit are shared with the first headphone unit in the second operational mode.

The various aspects, features and advantages of the disclosure will become more fully apparent to those having ordinary skill in the art upon careful consideration of the following Detailed Description thereof with the accompanying drawings described below.

### BRIEF DESCRIPTION OF THE DRAWINGS

FIG. 1 is an exemplary audio headset.

FIG. 2 illustrates an exemplary audio headset installed in an exemplary headband.

FIG. 3 is a partial inner side view of an exemplary headband.

FIG. 4 is a sectional view of an exemplary headband.

FIG. 5 illustrates an exemplary earphone pod and cushion assembly.

FIG. 6 illustrates an exemplary audio headset installed in an exemplary helmet.

FIG. 7 illustrates an exemplary audio headset installed in an exemplary clothing article.

FIG. 8 illustrates an exemplary audio headset electrical schematic.

### DETAILED DESCRIPTION

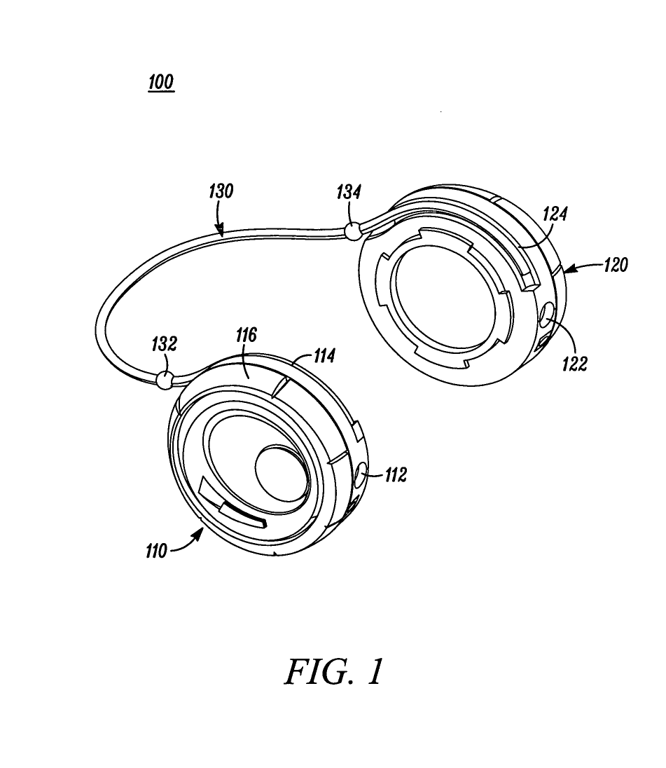

In FIG. 1, the exemplary audio headset 100 comprises generally a first earphone pod 110 housing a first audio transducer and a second earphone pod 120 housing a second audio transducer. The first and second earphone pods are interconnected by a lanyard 130. The lanyard functions generally to mechanically connect the earphone pods. In one embodiment, a fixed length lanyard is permanently fastened to the first and second earphone pods. In other embodiments, however, the lanyard is removably coupled to one or both earphone pods, for example, by mechanical fasteners, which may include electrical interconnections as discussed below.

In some embodiments, the lanyard also includes electrical conduits or conductors for accommodating the communication of data and/or control information and possibly power between the first and second earphone pods. These electrical conductors may be encapsulated within, wrapped about, or otherwise carried by the lanyard. Alternatively, the data and/or control signals may be communicated wirelessly between the earphone pods. In some alternative embodiments, the lanyard provides mechanical and possible electrical power coupling among the earphone pods. In other embodiments where there is a wireless connection between the earphone pods, the lanyard is not required.

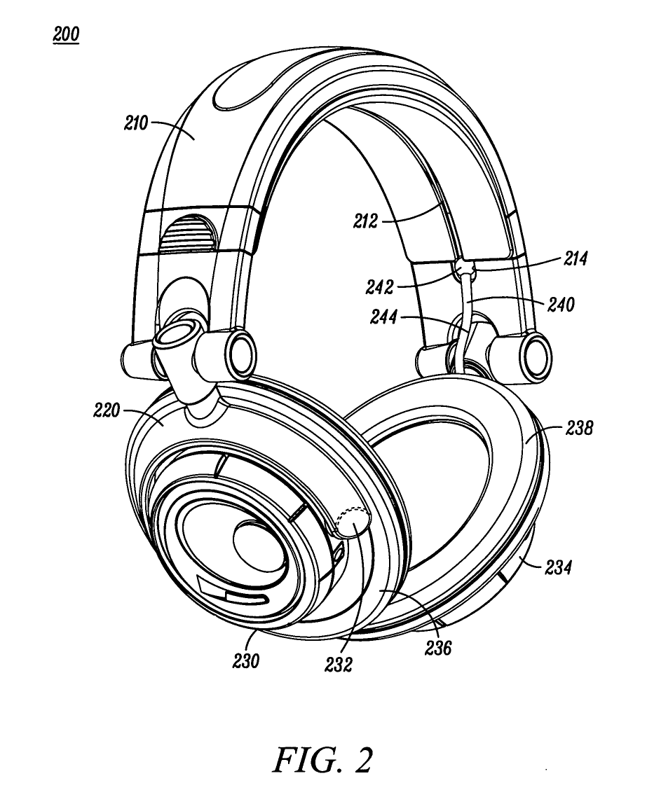

In one application, the exemplary audio headset, comprising first and second earphone pods interconnected by a lanyard, is fastened to a headband. In the exemplary embodiment of FIG. 2, the audio headset is removably installed in an over-the-head style headband 200 typical of those used by disk-jockeys. The over-the-head style headband is also referred to herein as a DJ-style headband. The exemplary headband comprises generally a band 210 with pod mounting portions formed on or coupled to opposite end portions thereof. The exemplary pod mounting portions are in the form of C-shaped members 220 that extend partially about corresponding earphone pods 230. The C-shaped members each include studs 232 protruding radially inwardly from opposite ends thereof. In FIG. 2, one stud 232 is illustrated in phantom because it is obstructed by the corresponding C-shaped member. The studs extend into corresponding openings or recesses formed on an outer surface of the earphone pods, thereby clamping the C-shaped member about the outer periphery of the pods. FIG. 1 illustrates exemplary stud recesses 112 and 122 in corresponding earphone pods 110 and 120, respectively. Each pod includes a second recess, which is not visible in FIG. 1. Thus configured, the earphone pods are removably mounted or coupled to the headband. In alternative embodiments, the earphone pods are removably coupled to the band by some other mechanism, the particular structure of which is not intended to limit instant disclosure. In FIG. 2, the exemplary earphone pod mounting portions are adjustably coupled to the band portion 210, thus permitting universal adjustment thereof. In other embodiments, the earphone pods are fixedly coupled to the mounting portions.

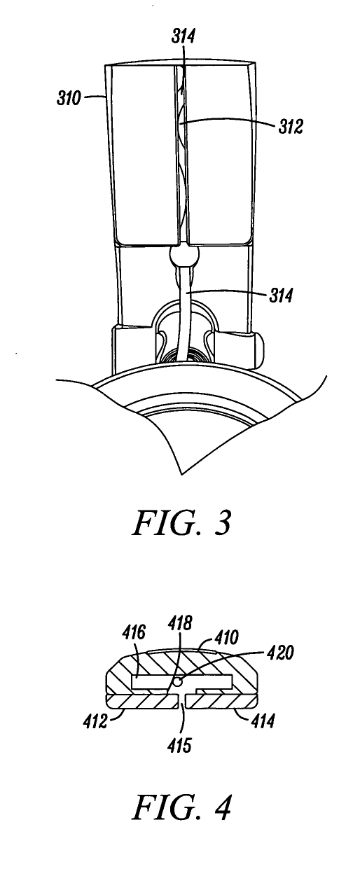

In FIG. 2, the band 210 includes a channel 212 on an inner portion thereof into which the lanyard 240 interconnecting the earphone pods is removably disposed and retained. In one embodiment, the channel is partially covered by a resilient member or portion, which is sufficiently flexible to permit insertion of the lanyard into the channel, which has an opening width that is slightly less than a diameter of the lanyard. FIG. 3 illustrates a band portion 310 with a slot or channel into which a lanyard 314 is disposed and retained. In the sectional view of FIG. 4, the headband 410 includes resilient flaps 412 and 414 fixedly disposed on the inner side of the band 410. The resilient flaps partially cover the band channel 416 in manner that restricts or narrows the channel opening 418. The lanyard 420 may thus be inserted into the channel 416 by depressing the lanyard into the relatively narrow gap 415 between the resilient flaps, flexing them inwardly. Upon returning to the non-flexed position, the resilient flaps subsequently retain the lanyard within the channel 416. The relatively narrow gap 415 at least partially covers the lanyard when the lanyard is disposed within the channel 416. The lanyard may be withdrawn from the channel by flexing the resilient flaps outwardly.

In some embodiments, the band portion 210 of FIG. 2 is adjustable, for example, by virtue of telescoping or reciprocating components capable of extension and retraction relative to each other as is known generally by those having ordinary skill in the art. To accommodate the variable spacing between earphone pods coupled to an adjustable headband, the length of the lanyard is at least as long as required to accommodate the longest separation contemplated between the earphone pods. The maximum separation may be imposed also by applications where installation occurs in articles other than headbands, for example, in helmets and clothing, examples of which are discussed further below. In FIG. 4, the headband channel 416 has a width sufficient to accommodate excess lanyard, which may be bunched in the channel. In FIG. 3, the channel 312 accommodates a lanyard 314 arranged in a serpentine pattern.

In some embodiments, the lanyard includes an indexing member located a fixed distance from each earphone pod. In FIG. 1, bead-shaped indexing members 132 and 134 are fastened about the lanyard 130 a fixed distance from each earphone pods. More generally, the indexing member may have shapes other than the exemplary beads. For example, the indexing members may be diamond or pin shaped members or have some other shape. The indexing members may be formed integrally with the lanyard or be components affixed thereto or assembled therewith. In one embodiment, the indexing member is a releasable clamp that may be positioned along the lanyard by the user. The indexing members generally provide a fixed amount of lanyard between the earphone pod and the accessory to which the audio headset is combined. In FIG. 2, for example, the indexing members 242 are disposed and securely retained in corresponding complementary recesses 214 formed in the band portion 210. In one embodiment, the recesses 214 have an opening sized smaller than the indexing member. The indexing member or the recess opening is sufficiently resilient to permit passage of the indexing member through the opening and into the recess, where the indexing member is securely retained. In FIG. 2, a lanyard portion 244 of optimal length extends between the earphone pod 234 and the band 210. The optimal length of the lanyard between the band and the earphone pod depends generally on the requirements of the particular application. In FIG. 2, the lanyard portion 244 is sufficiently long to permit articulation of the mounting members without entanglement of the lanyard. Other applications may have other requirements, for example, those without an articulating mounting portion may not require as much lanyard as articulating embodiments.

In an alternative embodiment, the audio headset and the headband to which it is attached comprise a single earphone pod, without a second pod and an interconnecting lanyard. In another alternative embodiment, the headband is of the type that extends horizontally about the posterior, or rear, portion of the head. In these and other applications, the lanyard extends horizontally rather than vertically. In one embodiment, to accommodate use of the exemplary audio headset in applications where the lanyard extends vertically or horizontally, each earphone pod includes a lanyard retention channel extending from upper portion of the earphone pod toward a rear portion of the earphone pod. In FIG. 1, for example, the earphone pods 110 and 120 each include a channel, or slot, 114 and 124, respectively, extending circumferentially from an upper portion of the pod toward a rear portion thereof. In one embodiment, the channels have a cross-sectional shape that is complementary to a portion of a section of the lanyard, wherein an opening width of the channels is narrower than the lanyard diameter. The lanyard is formed of a pliable material that is resiliently disposable into the channel where it is retained. Alternatively, the channel may be formed of a resilient material that yields sufficiently to accept and retained the lanyard. The lanyard is thus removably disposable in the lanyard retention channels of the earphone pods. In FIG. 1, for horizontal lanyard installation applications, the lanyard is disposed and retained in the slots 114 and 124 of the corresponding pods so that the lanyard extends from a rearward portion of the pods. For vertical lanyard installation applications, the lanyard extends upwardly from an upper portion of the earphone pods, without or without substantial entrenchment in the channels.

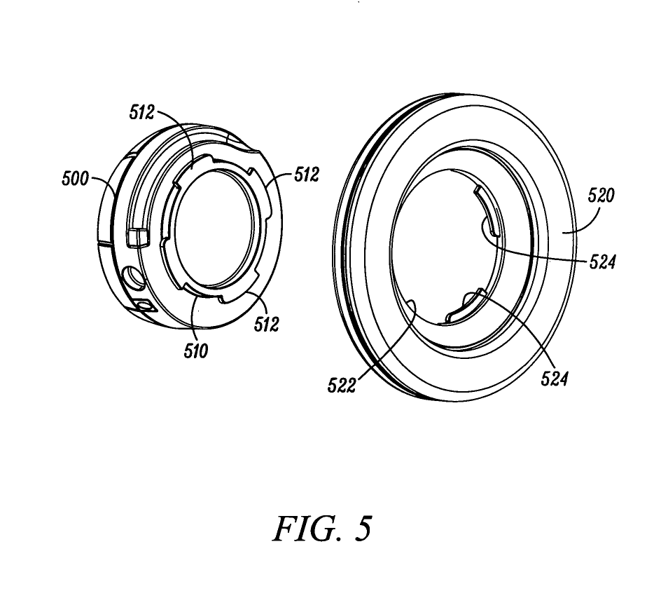

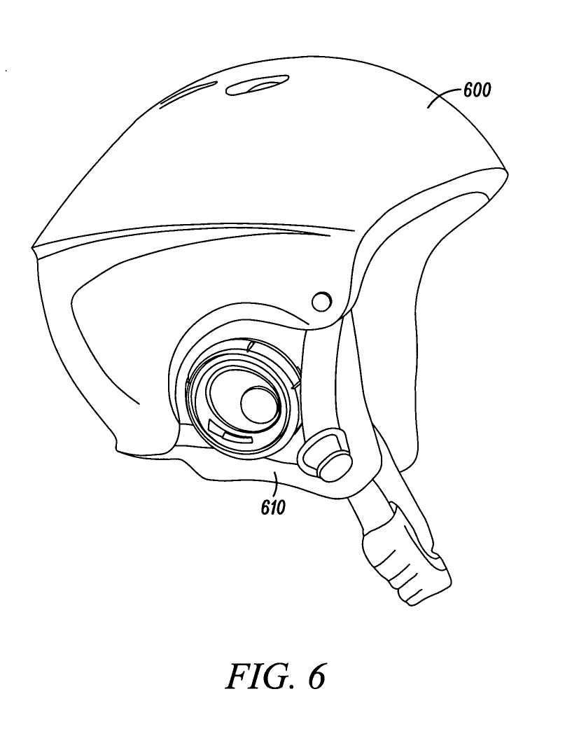

In some applications, the earphone pods include an annular ear cushion on the side thereof from which sound emanates. In the headband of FIG. 2, for example, each earphone pod 230 and 234 includes a cushion 236 and 238, respectively. In one embodiment, the cushions cup the users' ears to reduce environmental noise and to improve sound quality. The cushions may be permanently or removable fastened to the earphone pods. In FIG. 5, for example, the cushions are fastened to the pods with a bayonet-style fastener. More particularly, an earphone pod 500 is configured on its inner side with an annular lip 510 having spaced flanges 512 protruding radially outwardly from a distal end of the lip. The annular cushion 520 includes a central opening 522 with spaced flanges 524 extending radially inwardly. The spacing between the cushion flanges 524 is complementary to the arrangement of the pod flanges 512 so that the pod and cushion flanges are matingly disposable between one another in an axially offset manner. Upon locating the cushion flanges 524 between the pod flanges 512 and axially offsetting the flanges, the cushion and pod flanges are rotated into frictional engagement. Thus configured, the cushions are removably coupled to the earphone pods. In other embodiments, other fastening mechanisms are used to removably couple the cushions to the earphone pods. The disclosure is not to be limited by any particular mechanism for removably fastening cushions to the pods.

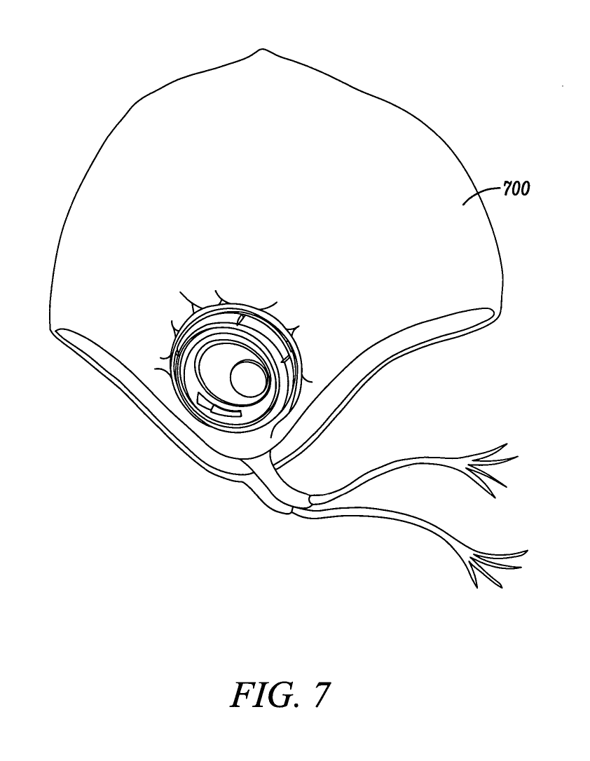

In another exemplary application, an audio headset comprising first and second earphone portions interconnected by a lanyard is installed within protective headgear. In FIG. 6, the audio headset is removably disposed within a helmet 600. Other exemplary helmets include those used by in-line skaters, skate-boarders, snow-boarders, water-skiers, and cyclists among other sports enthusiasts. In FIG. 6, the exemplary helmet 600 includes an ear flap 610 on opposite sides of the helmet with an aperture into which the earphone pods are removably disposed. In one embodiment, each ear flap includes flanges integrated therewith, for example, by an insert molding process, similar to the flanges of the cushion discussed above. In such a configuration, the helmet flanges cooperatively engage the pod flanges as discussed above in connection with the bayonet-style fastener illustrated in FIG. 5. In other embodiments, the earphone pods may be removably coupled to the helmet by other means, for example, by Velcro, or by insertion into a pouch or into a ski-boot style connector. Alternatively, the earphone pods may be coupled to a more rigid part of the helmet, for example, behind padding within the protecting casing. In embodiments where it is desirable to use cushions with the earphone pods, some mechanism other than flanges may be required to couple the earphones to the helmet. The lanyard may be disposed in a retention channel or otherwise securely retained within the helmet structure by any means.

FIG. 7 illustrates another alternative application where an exemplary audio headset comprising first and second earphone portions interconnected by a lanyard is installed within a garment in the exemplary form of a cap 700. Alternatively, the cap may be a hood integrated with a coat or other clothing article. In one embodiment, the cap includes flanges integrated therewith for cooperative engagement with the pod flanges as discussed above in connection with the bayonet-style fastener illustrated in FIG. 5. Alternatively, the earphone pods may be removably coupled to the cap by other means, for example, by Velcro, or by insertion into a pouch, etc. The lanyard may be retained below a material flap secured by buttons or by Velcro, or by other means. Thus generally, the exemplary audio headset comprising first and second earphone portions interconnected by a lanyard of FIG. 1 is removably installed or coupled to a variety of different garments and accessories, which are not to be limited by the exemplary cap, helmets and headphones discussed above.

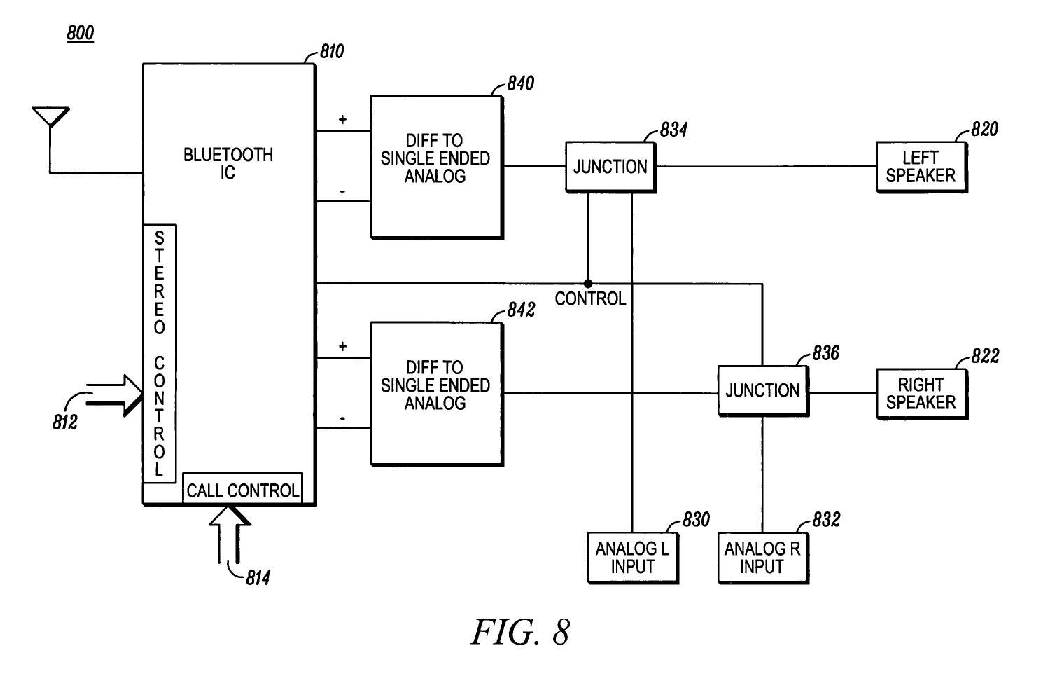

FIG. 8 illustrates an exemplary audio headset electrical circuit 800 comprising generally a wireless receiver 810 having at least one channel output discussed further below. The exemplary wireless receiver constitutes a transceiver compliant with the Bluetooth wireless protocol. In other embodiments, however, the receiver or transceiver is compliant with some other wireless communication protocol, for example, an infrared or radio frequency protocol. The exemplary Bluetooth transceiver is capable of receiving stereo signals, for example, an MP3 format signal, which is output to left and right channel transducers 820 and 822. The exemplary Bluetooth transceiver is also capable of receiving monaural audio signals, for example, a cellular telephone voice signal. The monaural audio signal may be routed to one or both speakers. In some applications where a cellular voice signal is received while receiving a stereo signal, for example, from an MP3 player integrated with the cellular handset from which the voice call was received, the voice signal is given priority over the stereo signal. The exemplary wireless receiver includes circuitry for processing incoming signals and generating stereo and/or monaural audio signals that may are output to one or more transducers.

In some embodiments, the wireless receiver is part of a transceiver, for example a Bluetooth IC, that includes an audio input, for example, from a microphone located on the headset. The exemplary Bluetooth IC includes circuitry for processing audio input and modulating a carrier compliant and transmitting in compliance with the Bluetooth protocol. In another alternative embodiment, the wireless receiver may provide an audio signal to a single transducer. The audio circuit may be located in one of the earphone pods. Alternatively, portions of the circuit may be disposed in both earphone pods. In the exemplary embodiment, the input and various controls are input to the wireless receiver, examples of which are discussed below. Alternative embodiments may include a discrete controller or processor to which the audio input and controls are input.

In some embodiments the audio circuit includes an analog audio signal input, for example, a stereo or monaural input jack. In FIG. 8, for example, the audio circuit 800 includes right and left channel analog stereo inputs 830 and 832. In the exemplary embodiment, each analog signal input 830 and 832 is coupled to a corresponding junction device 834 and 836, respectively. The right and left channel signal outputs of the wireless receiver are also coupled to a corresponding one of the junction devices. Audio signal outputs of the junction devices 834 and 836 are coupled to a corresponding one of the transducers 820 and 822. In the exemplary embodiment of FIG. 8, the Bluetooth receiver left and right audio signal outputs are coupled to the junction devices by corresponding differential to single-ended analog devices 840 and 842. The exemplary audio circuit thus accommodates audio signals from a wireless receiver and/or from an analog audio signal input source, examples of which are discussed further below.

In one embodiment, the junction devices include a signal selector circuit that selects audio from either the wireless receiver source or from the analog audio input signal source. Thus at any one time, the signal selector circuit outputs an audio signal from not more than one of the audio signals coupled thereto. In one embodiment, the wireless receiver includes a switch control output coupled to the signal selector circuits, whereby the switch control selects the signal passed by the selectors. In one exemplary embodiment, the switch control selects the audio signal output of the wireless receiver when an audio signal from the wireless receiver is available. In cellular telephone applications, for example, the control signal gives priority to audio signals from incoming telephone calls. It may also be programmed to give priority to stereo signals, for example, MP3 signals, received at the wireless receiver. In other embodiments, the user manually selects the signal passed by the selector using a user interface input. In some embodiments, the manual control overrides any default signal selection. An exemplary control could be in the form of an analog signal mute button.

In one particular implementation, for example, when the Bluetooth headset is OFF, the analog audio input signal is routed to the speakers all the time. When the Bluetooth headset is ON and it is not in a voice call or streaming music from the wireless receiver, the analog input signal is routed to the speakers. When the Bluetooth headset is in a voice call, the mono phone audio signal is routed to the speakers. When the Bluetooth headset is streaming music, the decoded stereo audio signal is routed to the speakers.

In another embodiment, the junction devices include a signal summer circuit that combines audio from the wireless receiver source and from the analog audio input signal source. The signal summer circuit thus outputs a combination of audio signals input to the summer. In some embodiments, the user manually controls the analog signal from a user interface input, for example, by actuation of a mute button. Such control enables the user to mute analog stereo input at the analog jacks. In one exemplary implementation, the Bluetooth IC mutes only the stereo audio generated at the Bluetooth IC. The inline analog audio would still play, unless muted at its source. In another embodiment, the Bluetooth IC mutes an additional analog stage to disable both the Bluetooth audio and inline audio.

In one embodiment where the wireless receiver is capable of receiving different audio signal, for example, MP3 audio and voice call audio signals, the audio headset includes separate controls for the different audio signals. Exemplary cellular voice call audio signal controls include, for example, a CALL/SEND command and an END call command, among other possible controls. Exemplary MP3 stereo signal commands include PLAY, PAUSE, STOP, NEXT (next track), FF (fast forward), PREV (previous track), REW (rewind), etc. There is also generally an audio volume control. In embodiments that include an analog signal input, at least some control of the audio signal is located at its source. As noted above, however, in some embodiments, the user may have the ability to mute this signal and control it volume. The disclosure is not limited by the particular audio signal controls or commands. In the exemplary embodiment of FIG. 8, the wireless receiver includes stereo control inputs 812 and voice call control inputs 814.

The earphone pods thus include a user interface for inputting these cellular telephone related commands. In one embodiment, the user interface is embodied as input keys or buttons. Controls or commands may be assigned to input keys or buttons and/or to combinations thereof. Also, multiple functions may be associated with individual keys based upon the duration for which the key is depressed. For example, a momentary press could actuate the PLAY functionality, a longer duration key press could actuate the PAUSE functionality, and a still longer duration key press could invoke the STOP functionality. Another key could control NEXT, FF and other functions. Other exemplary user interface inputs are discussed below.

In one embodiment, the controls for the different audio signals, for example, the MP3 and voice call signals, received by the wireless receiver are located on separate earphone pods. In one exemplary embodiment all of the wireless telephone call related controls are located on one earphone pod and all of the MP3 player or other accessory related controls are located on the other earphone pod.

In another embodiment, audio signals are controlled by a control wheel or knob disposed on one or both earphone pods. FIG. 1 illustrates an exemplary control wheel 116. In one embodiment, the control wheel is biased, for example, by a spring, to a home position, wherein the wheel is rotatable or pivotal against the bias over some angular range in forward and reverse directions. Pivoting the wheel forward invokes one function and pivoting the wheel backward invokes another function, for example, the volume UP and DOWN functions. In another embodiment, multiple functions may be controlled by pivoting the wheel in the same direction multiple times. For example, pivoting the wheel forward once may invoke the CALL function and pivoting the wheel forward again may invoke the END call function.

While the present disclosure and what are presently considered to be the best modes thereof have been described in a manner establishing possession by the inventors and enabling those of ordinary skill in the art to make and use the same, it will be understood and appreciated that there are many equivalents to the exemplary embodiments disclosed herein and that modifications and variations may be made thereto without departing from the scope and spirit of the inventions, which are to be limited not by the exemplary embodiments but by the appended claims.

What is claimed is:

1. An audio headset, the audio headset comprising:
a first earphone pod having a first audio transducer;
a first junction device;
a wireless receiver disposed in the first earphone pod, the wireless receiver having a first audio signal output coupled to the first audio transducer by the first junction device;
an analog audio input jack having a first audio signal output coupled to the first audio transducer by the first junction device.

2. The audio headset of claim 1,
the first junction device includes a first signal selector circuit,
the first audio signal output of the wireless receiver and the first audio signal output of the analog audio input jack coupled to inputs of the first signal selector circuit,
an output of the first signal selector circuit coupled to the first audio transducer,
whereby the first signal selector circuit outputs, at any one time, a signal from not more than one of the first audio signal outputs coupled to the input of the signal selector circuit.

3. The audio headset of claim 2, the wireless receiver includes a switch control output coupled to the first signal selector circuit, whereby the switch control output selects an output of the first signal selector circuit.

4. The audio headset of claim 3, the switch control output of the wireless receiver selects the first audio signal output of the wireless receiver when there is a signal at the first audio signal output of the wireless receiver.

5. The audio headset of claim 1,
the first junction device includes a first signal summer circuit,
the first audio signal output of the wireless transceiver and the first audio signal output of the analog audio input jack coupled to inputs of the first signal summer circuit,
an output of the first signal summer circuit coupled to the first audio transducer,
whereby an output of the first signal summer circuit is a combination of signals at the inputs of the first signal summer circuit.

6. The audio headset of claim 1,
a second earphone pod having a second audio transducer;
a lanyard interconnecting the first and second earphone pods,
a second audio signal output of the analog audio input jack coupled to the second audio transducer.

7. The audio headset of claim 5, an analog audio mute input on one of the first and second earphone pods.

8. The audio headset of claim 6, the wireless receiver constitutes a wireless transceiver.

9. The audio headset of claim 1,
a control wheel pivotally coupled to the earphone pod, the control wheel biased to a home position, the control wheel movable from the home position against the bias to at least first and second positions, the control wheel invoking first and second functions associated with the wireless receiver when pivoted to the corresponding first and second functions.

10. An audio headset, the audio headset comprising:
a pair of earphone pods, each earphone pod having an audio transducer;
a lanyard interconnecting the earphone pods;
a wireless receiver disposed in one of the earphone pods, the wireless receiver having an audio signal output coupled to at least one of the audio transducers;
an analog audio jack having an audio signal output coupled to the audio transducers.

11. The audio headset of claim 10,
a first signal selector circuit having inputs coupled to the audio signal output of the wireless receiver and to the audio signal output of the analog audio jack, the first signal selector having an output coupled to one of the audio transducers.

12. The audio headset of claim 10,
a first signal summer circuit having inputs coupled to the audio signal output of the wireless receiver and to the audio signal output of the analog audio jack, the first signal summer having an output coupled to one of the audio transducers.

13. The audio headset of claim 10,
a control wheel rotatably coupled to one of the earphone pods,
an audio signal control device actuatably coupled to the control wheel,
the control wheel rotatable between first and second positions, the control wheel actuating the audio signal control device in at least one of the first and seconds positions.

14. The audio headset of claim 13,
the control wheel biased in a home position by a biasing member, the control wheel rotatable between the home position and the first and second positions, the control wheel actuating the audio signal control device when rotated to either of the first and second positions.

15. The audio headset of claim 10, an ear cushion removably coupled to each of the earphone pods.

16. The audio headset of claim 10,
a headband having a band with pod mounting portions coupled to opposite end portions of the band,
one earphone pod removably coupled to one pod mounting portion, the other earphone pod removably coupled to the other pod mounting portion,
the headband having a channel covered by a movable flap, the lanyard removable disposed in the channel and covered by the movable flap.

17. The audio headset of claim 10,
the lanyard having an indexing member located a fixed distance from each earphone pod.

18. A method in an audio headset, the method comprising:
providing a first audio signal from a wireless receiver of the audio headset to at least one two audio transducers;
providing a second audio signal from an analog audio input to the audio headset to at least one of the two audio transducers;
controlling the first and second audio signal provided to the audio transducers.

19. The method of claim 18,
controlling the first and second audio signal provided to the audio transducers includes one of selecting one of the first and second audio signals provided to the audio transducers or combining the first and second audio signals provided to the audio transducers.

20. The method of claim 19,
selecting the first audio signal from the wireless receiver when both the first and second audio signals are present and when not combining the first and second audio signals.
